(19) United States
(12) Patent Application Publication
(10) Pub. No.: US 2015/0282250 A1
(43) Pub. Date: Oct. 1, 2015

(54) Vehicle Roof Defroster

(71) Applicant: Michael Vincent Smith, Media, PA (US)

(72) Inventor: Michael Vincent Smith, Media, PA (US)

(21) Appl. No.: 14/190,281

(22) Filed: Mar. 28, 2014

(51) Int. Cl. H05B 1/02; B60S 1/66

(52) U.S. Cl. CPC H05B 1/0236; B60S 1/66

(57) ABSTRACT

An outdoor study was conducted to assess the effects of a vehicle roof defroster line widths and separation of the connections located on the roof of a motor vehicle. Because additional independent variables were needed, including size, and location of the target areas, independent variables were length of time the defroster was on to properly melt snow or ice. Also, ratings of how easily these vehicle roof defrosters could be applied to various vehicle roof tops. There were two main findings. First, neither the width nor separation of the opaque lines, affected the roofs melting of snow or ice within the target areas. Second, the subjective ratings of the ease in which the vehicle roof defroster can be installed. These results suggest that drivers will agree to the increased safety, and decreased risk of not melting hazardous ice and snow from the roof of a vehicle.

### BACKGROUND OF THE INVENTION

The rear defroster on the back window of a vehicle has helped many drivers see more clearly over the past 40 years. The modern automotive rear window defroster is a sophisticated surface heater. The grid pattern of thin brown horizontal lines is made from a conductive silver ceramic compound which is first silk screened to the inside of the rear window and then baked at very high temperatures. These grids are hooked up to a high amperage circuit to provide rapid heating. The average defroster grid heats up to approximately 55° Fahrenheit and is very effective in clearing ice from the rear window. The heating elements have very low heat, so humans are in no danger of getting burnt if they are touched while powered on. Rear defrosters have saved a considerable amount of time during an ice storm or snow fall, allowing the driver to see safely as they drive home.

However, the top of the vehicle still remains a mound of ice and snow as the driver makes their journey. Since most car roofs are high and inaccessible, clearing the ice and snow from the top of the vehicle is a struggle. With today's legal ramifications, if a sheet of ice and/or snow becomes airborne, and lands on the vehicle behind them making the first driver liable. Tractor trailer drivers are especially at risk of causing a fatal crash. The roof defroster works the same way as a rear window defroster. The roof defroster is a simple electric heating grid with lines that are made of a mixture of metal and a type of adhesive, sprayed on, or a resin to bond it permanently to the vehicle roof surface. The roof defroster works just like any other electric heater where an electric current is passed through the grid, and the electrical resistance creates heat. To melt ice or snow, the elements only needs to warm to a temperature just above freezing (32 degrees F.). Which will still feel cold to the touch, but it's warm enough to do the job.

### BRIEF DESCRIPTION OF THE DRAWINGS

FIG. 1:

The three quarter view of the tractor-trailer.

Showing the heating elements and the position of the external parts. The roof surface of the tractor trailer is covered from front to back, with the adhered wire harness.

The system uses a control switch which will determine the amperage needed—12-24 volts. The harness is routed to the dash, and a control switch is used to operate the defroster.

FIG. 2:

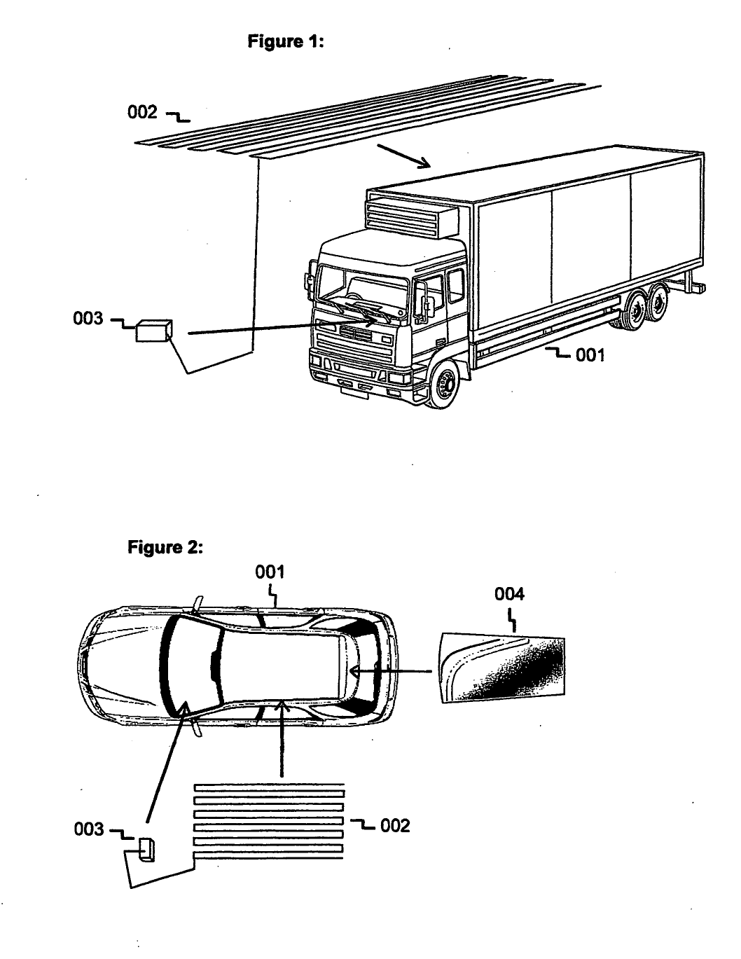

The top view of the vehicle.

Showing the heating elements and the position of the external parts. The roof surface of the vehicle is covered from front to back with the wire harness.

The system uses a control switch which will determine the amperage needed—12-24 volts. The harness is routed to the dash, and a control switch is used to operate the defroster.

A car wrap is used to conceal and protect the harness.

### SUMMARY OF THE INVENTION

The roof defroster can be applied directly to existing roofs, as freezing rain or snow accumulates the roof defrosters performance begins by clearing, and melting snow and ice in minutes. The roof defroster will be available in many sizes for defrosting tractor trailers, cars, SUV's, and hundreds of other vehicles. The roof defroster consists of a cost effective and easy to install new method. The roof defrosters are available in 12 or 24 volt., and will come with easy to follow step-by-step instructions, which allow the owner to install it themselves, or have it done professionally. Measure and determine the size of the area to apply the unit to. The defroster area should have at least 1.5 inches (4 cm) clearance from the edges on all sides. The elements do not need to completely fill the area to be effective. Measure the defroster area in length and width because accuracy counts in this step.

### EXAMPLE

This defroster area is 72 inches in length (top/bottom) and 36 inches in width (left/right). The 24 volt defrosters are specially designed to work with 24 volt systems. Cost effective and easy to install, new defrosters are trimmed size during installation for a custom fit with an attractive factory look. Available as complete defrosters including automatic timer or as defroster only option ideal for defroster replacement using existing wiring. DO NOT USE 12 Volt defrosters in 24 volt systems.

1. The present process of the invention as it relates to the use of a roof defroster which is used to melt ice and snow from the top of a vehicle, such as a car, SUV, truck, van, or tractor trailer.

2. The control units are the perfect companion for the Roof Defroster. Available in four models from the simple automatic ten minute timing to more sophisticated adjustable automatic shut off timing, power modulation and network control allowing a single switch to control multiple defrosters.

3. The thermal controls can activate several defrosters at once through a single switch, making the system ideal for multiple defroster installations. The thermal controls can modulate the apparent power to the defroster from 3% up to 100%. This feature enables hundreds of new Roof Defroster sizes to fit almost any roof in 12 and 24 volt.

4. The automatic timing symbol on the remote switch will turn the defroster on. The defroster stays on until the switch is pressed again or the thermal control times out. The control can be set to time out from 10 to 160 minutes or can be left on indefinitely depending on the internal jumper settings.

5. One single switch multiple defroster can activate many defrosters using the thermal control. This network control is good for applications that require several defrosters to be activated from a single switch. Mounting the thermal control can be secured out of sight under the dash while the switch can be mounted remotely in dash. A separate under dash mount is included with full kits.

6. Installation options for the Roof Defrosters and thermal controls are available individually or with a full installation package including a wire harness, fuse, fuse holder, switch mounting plate, power tap, wire ties, car wrap, surface cleaner/adhesion promoter and full instructions. The Roof Defroster can fit any roof surface. Measure the Defrost Area and allow at least a 3 inch clearance from the roofs edge. The defroster length (front-to-back) is fixed by the number of grid lines and cannot be changed. The defroster width (side-to-side) can be trimmed within the minimum and maximum defroster sizes. The length includes the tab ends which are ⅝ in (1.6 cm).

7. Peak current is obtained by dividing the Voltage at the heater by the Resistance of the heater. It is important that the 25 ampere rating of the electronic switch not be exceeded. It is also important in calculating the voltage drop in the circuit feeding the heaters, and is independent of duty cycle.

8. RMS current is the current that actually does the heating. It is obtained by multiplying the Peak Current times the square root of the duty cycle. To obtain adequate heat on the roof, the RMS current needs to be at least 2.75 amperes in all conductors, and to prevent over heating the roof, cannot be greater than 4.3 amperes in any conductor.

9. Average current represents the amount of drain on the battery. It is obtained by multiplying the Peak Current times the duty cycle. If the roof is warmed for ten minutes without the engine running, the ampere-hour drain on the battery, the battery drain will never exceed a comfortable 4.2 Ah. The line width is proportional to the angle of oscillation (α). Since the angle can be modified one tick line at the time the ruler can have major and minor lines.

10. Since fuses are sensitive to RMS current, recommended fuse ratings should be at least 20% higher that the RMS current. Standard automotive fuse ratings are 5.0A, 7.5A, 10A, 15A, 20A, 25A and 30A. So the recommended fuse rating is obtained by multiplying the maximum RMS current times 1.2 and selecting the next higher standard fuse.

11. Duty Cycle is defined as the time that the heater is ON divided by the time the heater is OFF plus the time the heater is ON, and is generally express in percent. If the heater is ON all the time, the duty cycle is said to be 100%.
